(19) United States
(12) Patent Application Publication
(10) Pub. No.: US 2024/0301968 A1
(43) Pub. Date: Sep. 12, 2024

(54) Beam Clamp

(71) Applicant: ERICO International Corporation, Solon, OH (US)

(72) Inventors: Nathan J. Petek, Chagrin Falls, OH (US); Raymond M. Olle, Valley View, OH (US)

(21) Appl. No.: 18/600,326

(22) Filed: Mar. 8, 2024

Related U.S. Application Data
(60) Provisional application No. 63/489,117, filed on Mar. 8, 2023.

(51) Int. Cl. F16L 3/00; F16M 13/02

(52) U.S. Cl. CPC F16L 3/00; F16M 13/022; F16M 13/027

(57) ABSTRACT

A beam clamp can include side walls configured to receive a beam, and cross-walls that extend between the side walls. A first cross-wall can include a first threaded opening to receive a threaded rod along a first axis and a second threaded opening to receive a set screw. A second cross-wall can include a third opening aligned with the first threaded opening along the first axis.

### CROSS REFERENCE TO RELATED APPLICATIONS

This application claims priority to and incorporates by reference U.S. provisional patent application No. 63/489,117, filed Mar. 8, 2023.

### BACKGROUND

In many applications, it may be useful to suspend equipment such as conduit, pipe, and ducts from beams of a building. For example, equipment may be secured to a threaded rod that is itself secured to a beam with a clamp. Suspending the equipment from the ceiling may help to create extra usable space in an interior of the building.

### SUMMARY

A beam clamp can include a clamp body. The clamp body may include a first side wall that may form a first hook profile and a second side wall that may form a second hook profile. The first and second hook profiles may be arranged to receive a beam simultaneously to hang the clamp body from the beam. The second side wall may include an aperture (e.g., a recess extending into an edge of the second side wall at a second end of the clamp body). The clamp body may further include a first cross-wall that extends between the first and second side walls at a first end of the clamp body. The first cross-wall may include a first threaded opening and a second threaded opening. The first threaded opening may be sized to receive and threadedly engage a threaded rod along a first axis. The clamp body may also include a second cross-wall that extends between the first and second side walls at a second end of the clamp body that is opposite the first end. The second cross-wall may extend integrally from the first side wall. The second cross-wall may include a third opening aligned with the first threaded opening along the first axis to receive the threaded rod along the first axis when the threaded rod extends through the first threaded opening. The second cross-wall may also include a tab that is received into the aperture in the second side wall so that contact between the tab and a wall of the aperture blocks movement of the tab in a direction perpendicular to the first axis.

A beam clamp may include a first side wall with a first C-shaped profile configured to receive a beam. The beam clamp may further include a second side wall with a second C-shaped profile configured to receive the beam simultaneously with the first C-shaped profile. The beam clamp may also include a first cross-wall that extends integrally from and between the first and second side walls at a first end of the beam clamp. The first cross-wall may include an extruded first threaded opening that defines a first axis to receive a threaded rod and an extruded second threaded opening that defines a second axis to receive a set screw. The beam clamp may further include a second cross-wall that extends integrally from the first side wall and between the first and second side walls at a second end of the beam clamp. The second cross-wall may include a third unthreaded opening aligned with the extruded first threaded opening along the first axis.

A method of installing a support system can include providing a beam clamp that may include a first side wall that forms a first hook profile and a second side wall that forms a second hook profile. A first cross-wall may extend between the first and second side walls at a first end of the clamp body, and a second cross-wall mat extend between the first and second side walls at a second end of the clamp body that is opposite the first end. The second cross-wall may extend integrally from the first side wall, and the second cross-wall may include a tab that is received into an aperture in the second side wall at the second end of the clamp body. Additionally, the method may include aligning a threaded rod with a first opening disposed in the second cross-wall. The method may further include tightening the threaded rod into a second threaded opening disposed in the first cross-wall and aligned with the first opening. The method may also include tightening a set screw into a third threaded opening disposed in the first cross-wall.

### BRIEF DESCRIPTION OF THE DRAWINGS

The accompanying drawings, which are incorporated in and form a part of this specification, illustrate examples of the disclosed technology and, together with the description, serve to explain the principles of the disclosed technology:

FIG. 1 is a front, left isometric view of a clamp system, with an example beam clamp;

FIG. 2 is a front, right isometric view of the beam clamp of FIG. 1;

FIG. 3 is a front, left axonometric view of the beam clamp of FIG. 1;

FIG. 4 is a right side elevation view of the beam clamp of FIG. 1;

FIG. 5 is a left side elevation view of the beam clamp of FIG. 1;

FIG. 6 is a top plan view of the beam clamp of FIG. 1;

FIG. 7 is a bottom plan view of the beam clamp of FIG. 1;

FIG. 8 a front elevation view of the beam clamp of FIG. 1;

FIG. 9 is a rear elevation view of the beam clamp of FIG. 1;

FIG. 10 is a left side elevation view of the clamp system of FIG. 1 clamped to a beam in a first orientation; and

FIG. 11 is a front, right axonometric view of the beam clamp system of FIG. 1 clamped to a beam in a second, reversed orientation.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other examples and of being practiced or of being carried out in various ways.

The following discussion is presented to enable a person skilled in the art to make and use examples of the disclosed technology. Various modifications to the illustrated examples will be readily apparent to those skilled in the art, and the generic principles herein can be applied to other examples and applications without departing from the principles of the disclosed technology. Thus, the disclosed technology is not intended to be limited to embodiments shown, but is to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of the disclosed technology. Skilled artisans will recognize the examples provided herein have many useful alternatives that also fall within the scope of the disclosed technology.

As noted above, in some contexts, it may be useful to suspend equipment (e.g., conduit, pipe, and ducts) above the ground in buildings. In some contexts, the equipment may be suspended from a threaded rod that is secured to a beam. For example, equipment can be suspended directly by the threaded rod or via various intervening devices (e.g., various known clamp or strut arrangements).

Examples of the disclosed technology can provide clamps that can be selectively installed in multiple orientations, to provide flexibility of installation without loss of load rating. In some examples, a stamped clamp can be provided that is capable of withstanding loads similar to or greater than clamps that are manufactured using casting. Thus, some examples can be rated to suspend relatively heavy loads in either of two orientations, while also being manufacturable at significantly reduced cost. However, although some examples herein describe stamped designs, other clamps could be manufactured using other methods (e.g., casting).

In some examples, a clamp system may include a clamp with a first threaded opening and a second threaded opening. The first threaded opening may be configured to receive a support rod. The second threaded opening may be configured to receive a clamp fastener. For example, the clamp fastener may be a set screw configured to secure the clamp to a beam or strut.

In some examples, the clamp may further include a third opening (e.g. an unthreaded opening). When the clamp is installed in an inverted orientation (e.g., with the set below the relevant beam flange), the third opening may be aligned with the first opening, so that both openings can receive the support rod along a first axis when the support rod is engaged with the clamp to support equipment. Thus, the material of the clamp that borders the third opening can provide an additional engagement point with the support rod during loading (e.g., with material of a bottom cross-wall of the clamp). Correspondingly, some examples of the disclosed clamp can result in reduced deformation of the support rod and a generally improved inverted load rating, as compared to conventional designs

In some examples, a clamp as generally described above may include a first side wall that forms a first hook (e.g., C-shaped) profile and a second side wall that forms a second hook (e.g., C-shaped) profile. The first and second hook profiles may be arranged to receive a beam and simultaneously hang the clamp body from the beam. Cross-walls that include the first and third openings can extend between side walls of the clamp and thus both reinforce the side walls and align the openings to collectively receive the support rod.

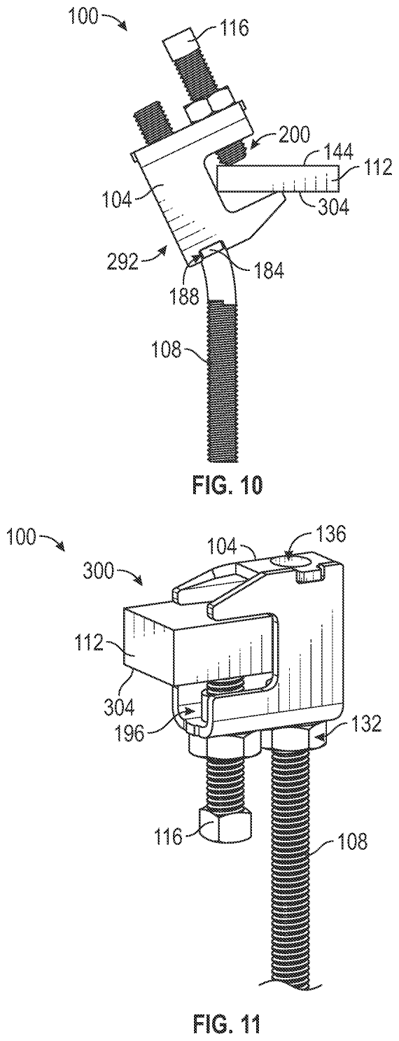

As one example, FIG. 1 illustrates a clamp system 100, for supporting equipment (not shown), which can be installed to hang from support beams or other structures that may include protrusions, on the exterior or interior of a building. In the example shown, the clamp system 100 includes a clamp 104, a support rod 108, and a clamp fastener 116 (e.g., a set screw, as shown). The clamp 104 shown is in a first orientation, but can be otherwise installed (as further discussed below). A beam may be received by the clamp 104 and fastened to the clamp using the clamp fastener 116 (see, e.g., FIGS. 10 and 11). With the clamp 104 secured to the beam 112, the support rod 108 may extend downward from the clamp 104 and may thus support equipment such as struts, conduit, pipes, ducts, etc. (not shown). The support rod 108 may further be secured to the clamp 104 via one or more support nuts 132 or other known fasteners.

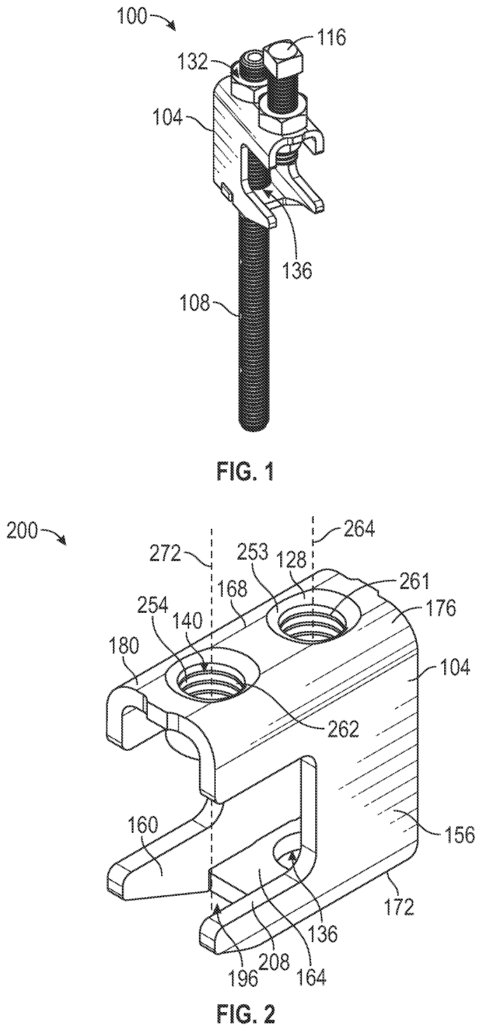

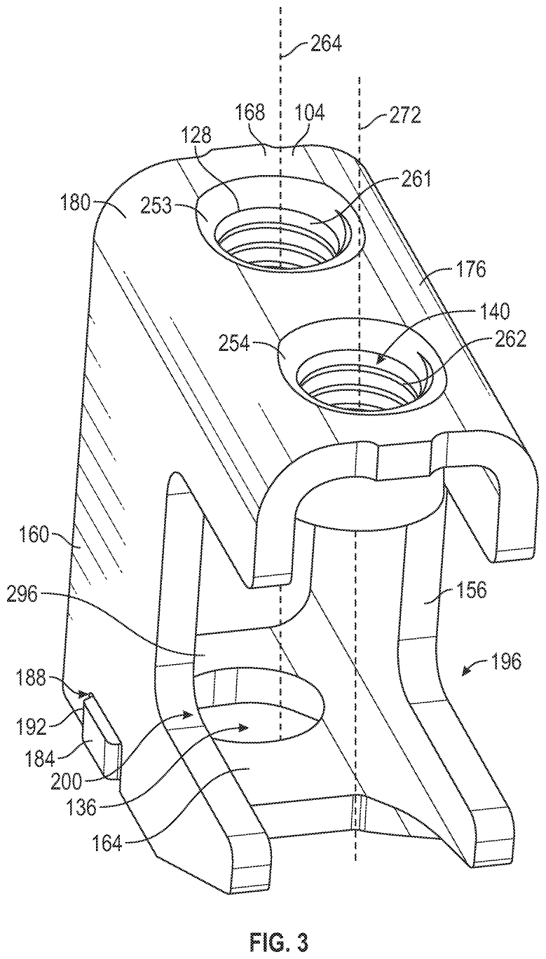

Referring now also to FIGS. 2 and 3, the clamp 104 includes a first opening 128 configured to receive the support rod 108 and a second opening 140 configured to receive the clamp fastener 116 (shown as a set screw in FIGS. 2 and 3). In particular, the first opening 128 and the second opening 140 may be threaded (e.g., with the same thread sizes).

As shown in FIG. 1 in particular, in the present orientation, the support rod 108 may extend through the first opening 128 and through a third opening 136. In this regard, it can be seen that the third opening 136 may be aligned with the first opening 128 along a common axis and a threaded rod can thus be received continuously through the openings 128, 136 without deformation (as shown in FIG. 1). Correspondingly, the third opening 136 may be variously sized to receive various sizes of the support rod 108. Furthermore, the third opening 136 may be unthreaded to case reception of the support rod 108. Thus, as further discussed below, the third opening 136 may generally extend a range of contact between the support rod 108 and the clamp 104 over a significantly longer distance than in conventional designs (e.g., with contact points for the support rod 108 at opposing ends of a volume of the clamp 104 defined between side walls of the clamp 104).

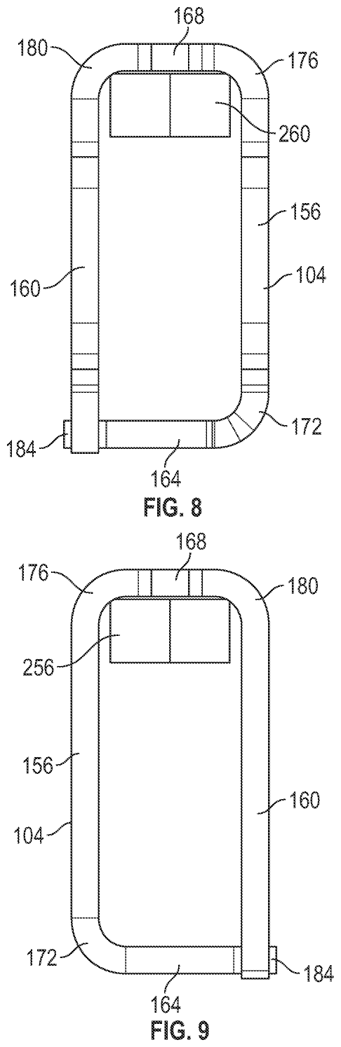

FIGS. 2-9 illustrate various additional details of the example clamp 104 of FIG. 1. In particular, the clamp 104 may include one or more walls that are integrally formed using a stamping (or other) process. Correspondingly, although particular relative dimensions, material thicknesses or bend types (e.g., fillets) are discussed below, those of skill in the art will recognize that many variations are possible.

In the illustrated example, the clamp 104 includes a first side wall 156 and a second side wall 160, connected by a first cross-wall 164 and a second cross-wall 168. In some examples, the first and second side walls 156, 160 may each integrally extend from the first cross-wall 164. Furthermore, as will be discussed below, at least one of the first and second side walls 156, 160 may not extend integrally from the second cross-wall 168. The first side wall 156 and the second side wall 160 may be substantially parallel. The first side wall 156 or the second side wall 160 may extend upward substantially perpendicular from the first cross-wall 164 or the second cross-wall 168.

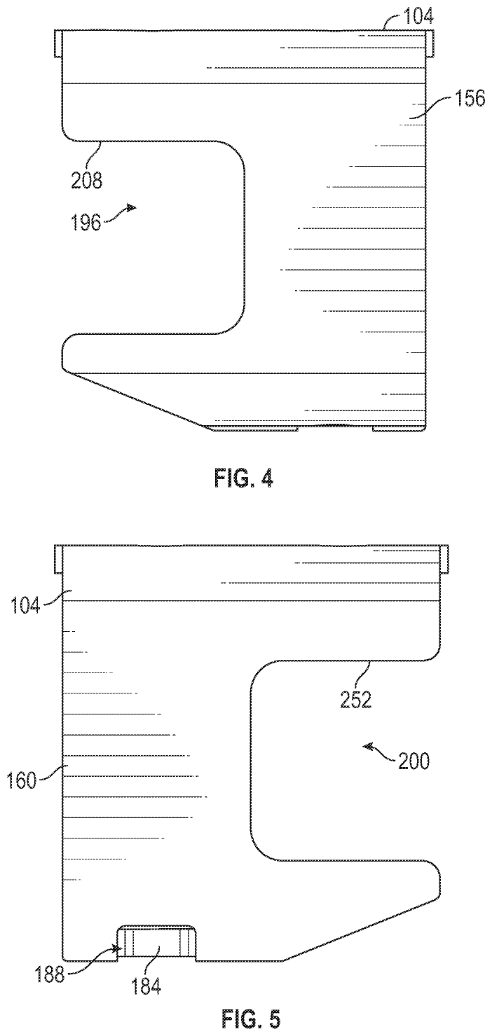

The first cross-wall 164 may be continuously connected to the first side wall 156 by a first filleted edge 172 and joined to the second side wall 160 in various ways (e.g., via cold formed engagements, as further discussed below). The first cross-wall 164 may extend only partially along the first side wall 156 or the second side wall 160 and the second cross-wall 168 may extend only partially along the first side wall 156 or the second side wall 160, relative to a clamping direction, (e.g., right-to-left in FIG. 4). The first side wall 156 and the second cross-wall 168 may be continuously connected by a second filleted edge 176, and the second side wall 160 and the second cross-wall may be continuously connected by a third filleted edge 180. In some examples, as also generally noted above, one or more of the first, second, or third filleted edges 172, 176, 180 may be cornered or otherwise contoured differently than shown. Further, some examples can include differently shaped or contoured side or cross-walls than shown (e.g., with embossed reinforcement features).

Referring to FIG. 7, a clamp can be secured together in some cases with cold forming operations. For example, the second side wall 160 may be coupled to the first cross-wall 164 via a tongue 184 (e.g., a rectangular tab, as shown) that extends from the first cross-wall 164. The second side wall 160 may include a corresponding aperture that is configured to receive the tongue 184. For example, as illustrated, a recess 188 (e.g., a rectangular slot or notch, as shown) can receive tongue 184 through an open side thereof, along the free end of the side wall 160. The tongue 184 may thus, for example, be press-fit into the recess 188 to secure the clamp 104 in its final shape, although other approaches are possible (e.g., with a welded connection). In some examples, the tongue 184 may include a flared periphery 192 to further wedge the tongue 184 within the recess 188. As further discussed below, inclusion of the tongue 184 in particular—or other similar structures—can complement the inclusion of the opening 136 in the cross-wall 164 to provide improved structural support for suspended rods. In some examples, an aperture to receive a tongue of a cross-wall can instead be formed with an enclosed perimeter (e.g., as a rectangular aperture spaced apart from the free end of the side wall 160).

The tongue 184 is shown having a rounded rectangular shape, with a corresponding profile for the recess 188. In some examples, the tongue 184 may be any shape (e.g., rectangular, trapezoidal, etc.) and the shape of the recess 188 can also be varied accordingly. In some examples, the first cross-wall 164 may include multiple tongues that are received by multiple recesses on the second side wall 160. In some examples, a similar tongue and recess configuration can be used to connect other walls of the clamp 104.

Thus, in some examples, the clamp 104 may be stamped from a single-piece blank. In other words, material for the walls 156, 160, 164, 168 may be continuously connected and then stamped in successive cutting or bending operations to reach the desired shape. In some examples, the clamp 104 may be integrally formed via other manufacturing methods, including casting. Once the clamp 104 is stamped (or otherwise formed), appropriate post-machining can then be implemented as needed (e.g., the first opening 128 and the second opening 140 may be threaded).

Referring to FIGS. 2-5, an outer periphery of the first side wall 156 may include a first profile 196 and an outer periphery of the second side wall 160 may include a second profile 200, generally configured to receive a beam (see FIGS. 10 and 11). In particular, the first profile 196 may define a first hook shape 208 and the second profile 200 may define a second hook shape 252. In some examples, the first and second profiles 196, 200 may be C-shaped (e.g., with a squared profile, as shown). In other examples, however, other profiles are possible, including other hooked profiles (e.g., with teeth, ridges, or other more complex geometry).

Referring to FIG. 3 in particular, a first entrance 253 to the first opening 128 and a second entrance 254 to the second opening 140 may be tapered or otherwise countersunk. Such an arrangement, for example, can help guide the support rod 108 and the clamp fastener 116 into the first opening 128 and the second opening 140.

As shown in FIGS. 7, 8, and 9, the first opening 128 may be formed within a first extrusion 256 (or other protrusion), and the second opening 140 may be formed within a second extrusion 260 (or other protrusion). The first extrusion 256 may define a cylindrical shape extending from the first cross-wall 164 toward the second cross-wall 168. An interior of the cylindrical first extrusion 256 may include a first set of internal threads 261 (as shown in FIG. 3) configured to threadedly receive and retain the support rod 108 (not shown). Similarly, the second extrusion 260 may define a cylindrical shape extending from the first cross-wall 164 toward the second cross-wall 168. An interior of the cylindrical first extrusion 256 may include a second set of internal threads 262 (as shown in FIG. 3) configured to threadedly receive and retain the clamp fastener 116 (see FIG. 1). The first and second extrusions 256, 260 may provide further support to the support rod 108 and the clamp fastener 116 respectively, by limiting a radial movement of the support rod 108 and the clamp fastener 116 relative to a center axis (not shown) of either the support rod 108 or the clamp fastener 116 (see FIG. 1).

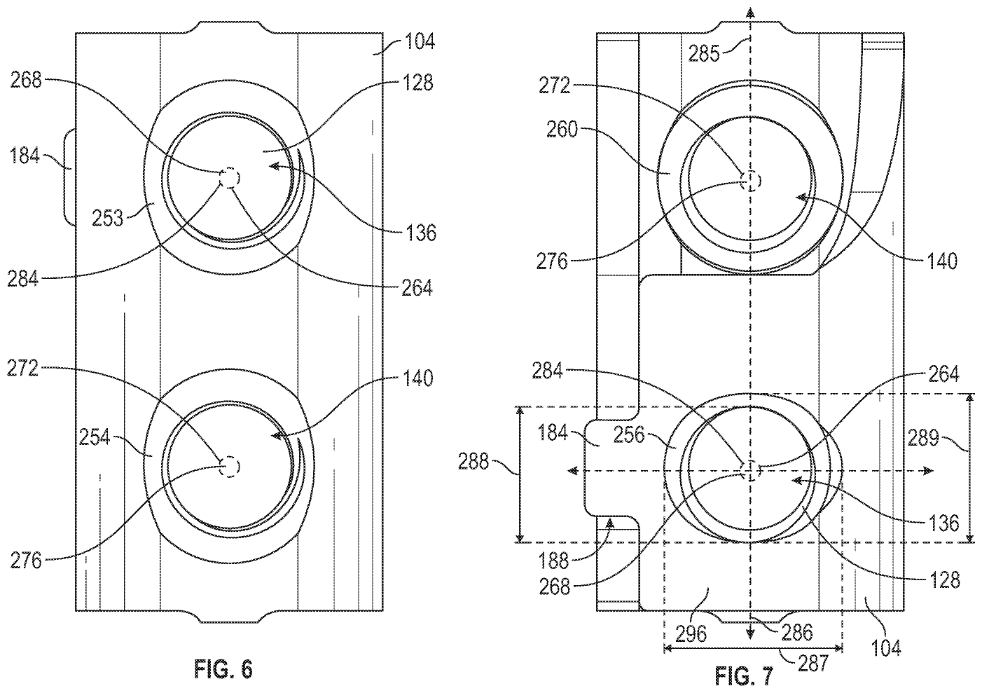

As shown in FIGS. 2 and 3 in particular, the first opening 128 may define a first axis 264 that extends from a first opening center 268 perpendicularly to the second cross-wall 168. The second opening 140 may define a second axis 272 that extends from a second opening center 276 perpendicularly to the second cross-wall 168. Further, as shown in FIG. 3, the third opening 136 may be in alignment with the first opening 128 along the first axis 264 to receive the support rod 108. For example, a third opening center 284 may be disposed on the first axis 264, as shown in FIGS. 6 and 7, so that the first and third openings 128, 136 are co-axial.

Generally, the third opening 136 can be sized to both easily receive the support rod 108 and also prevent excessive movement of the support rod 108 transverse to the first axis 264. As illustrated in FIG. 7, the third opening 136 may define an oblong shape, which may help to streamline installation, including for rods that exhibit a degree of deformation. Specifically, the third opening 136 may define a major axis 285 (e.g., an axis along a longest diameter of the third opening 136) and a minor axis 286 (e.g., an axis along a shortest diameter of third opening 136) that both extend through the third opening center 284. The major axis 285 may be longer than the minor axis 286. In some examples, the major axis 285 may be aligned along a direction between the first and second side walls 156, 160. For example, the major axis 285 may intersect the first and second side walls 156, 160.

In some examples, the third opening 136 may be aligned with the tongue 184 along a line that extends perpendicularly between the first and second side walls 156, 160. For example, one of the major or minor axes 285, 286 may be substantially perpendicular to the first and second side walls 156, 160, and may further intersect a portion of the tongue 184.

Referring still to FIG. 7, in some examples, a major diameter 287 of the third opening 136 along the major axis 285 may be greater than a first diameter 288 of the first opening 128. Similarly, a minor diameter 289 of the third opening 136 along the minor axis 286 may be greater than the first diameter 288 of the first opening 128. As generally discussed above, the major or minor diameters 287, 289 being greater than the first diameter 288 may account for inconsistencies in the support rod 108 during installation. For example, the major and/or minor diameters 287, 289 being greater than the first diameter 288 may allow the support rods (not shown) that are slightly bent, crooked, or otherwise misshapen to freely rotate within the third opening 136, as the support rods are tightened into the first opening 128.

Although the above discussion relates to third opening 136 defining an oblong shape, a variety of sizes and shapes are possible (e.g., rectangular, circular, triangular, trapezoidal, ovular, etc.). Further, although the third opening 136 is shown as a closed-sided opening, in some examples the third opening 136 may not define a closed perimeter (e.g., may be an elongated slot or other open-sided opening), although a solid portion of the first cross-wall 164 should generally be aligned on an opposite side of the first axis 264 from a beam received into the hooked profiles 196, 200.

As shown in FIG. 10, in the first orientation, the first cross-wall 164 may be disposed above the second cross-wall 168 in a direction defined by gravity. Furthermore, the clamp fastener 116 can extend through the second opening 140 (see FIG. 2) to engage an upper surface 144 of a beam 112 that is received into the profiles 196, 200. The clamp fastener 116 can thus secure the clamp 104 to the beam 112. In the first orientation, the support rod 108 may support a load hanging in a first direction. Thus installed, when the support rod 108 experiences significant loading, the support rod 108 may begin to bend toward a rear side 292 of the clamp 104, as shown in FIG. 10. However, a rear wall portion 296 of the cross-wall 164, adjacent to the third opening 136, may prevent the support rod 108 from bending (e.g., so that the support rod 108 remains substantially straight within the volume of the clamp 104). As shown in FIG. 10, the support rod 108 may instead bend at a location below the clamp 104, with corresponding improvements in overall integrity and load rating.

In contrast, support rods similarly installed with conventional clamps may bend within a volume of the clamps and thus bend significantly more sharply, with corresponding detrimental effects on load rating. For example, a support rod bending within the volume of a conventional clamp may cause a drastic increase in stress on sidewalls of a clamp. Because the support rod 108 does not bend within the volume of the clamp 104, the inclusion of the first cross-wall 164 and the third opening 136 may improve the stress (e.g., shear) characteristics of the clamp 104, allowing the clamp 104 to suspend much greater loads as compared to conventional designs.

As a further benefit, inclusion of the tongue 184 can further assist in supporting a support rod in some installations. For example, as detailed above, the tongue 184 extends from the cross-wall 186 into alignment with material of the side wall 160. Correspondingly, loading of the rod 108 transverse to its axis (as shown in FIG. 10) can be resisted not only by the cross-wall 164 but also by positive engagement between the tongue 184 and the side wall 160, with the side wall 160 aligned to provide mechanically blocking force to the tongue 184 transverse to the rod 108. Thus, the clamp 104 overall may exhibit significantly improved structural integrity as compared to some conventional designs.

As noted above, some clamps according to the disclosed technology can be readily installed in either of two opposed orientations. For example, FIG. 11 illustrates the clamp 104 in a second orientation, in which the first cross-wall 164 may be disposed below the second cross-wall 168 in a direction defined by gravity. Further, the clamp fastener 116 may engage a bottom surface 304 of the beam 112, to secure the clamp 104 in place. In the second orientation, the support rod 108 may support a load hanging in a second direction. The support rod 108 can thus extend from the first opening 128 away from the first cross-wall 164. Though FIG. 11 depicts the support rod 108 as only extending through the first opening 128, the support rod 108 may still extend through the third opening 136 in some installations (e.g., to provide further adjustability of a length of the support rod 108). In some installations, the second orientation may allow for the installation of the clamp in tighter spaces, where it may be preferred that the clamp fastener 116 extends downward.

Thus, examples of the disclosed technology can provide improved systems for supporting conduit, piping, duct, or other equipment that is hung from beams or other building structures. Some examples provide a clamp that is inexpensive to manufacture while still being capable of supporting heavy loads. Further, some examples may be reversible from a first orientation to a second orientation to allow for versatility of installation by the customer.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular example and perspective described. For example, reference to features or directions as “horizontal,” “vertical,” “front,” “rear,” “left,” “right,” “upper,” “lower,” and so on are generally made with reference to a particular figure or example and are not necessarily indicative of an absolute orientation or direction. However, relative directional terms for a particular example may generally apply to alternative orientations of that example. For example, “front” and “rear” directions or features (or “right” and “left” directions or features, and so on) may be generally understood to indicate relatively opposite directions or features for a particular example, regardless of the absolute orientation of the example (or relative orientation relative to environmental structures). “Lateral” and derivatives thereof generally indicate directions that are generally perpendicular to a vertical direction for a relevant reference frame.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

As used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive. Similarly, “substantially straight” indicates a linear line or object that deviates less than ±12 degrees from a center axis of that line or object (e.g., within ±6 degrees or ±3 degrees), inclusive.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed examples is provided to enable any person skilled in the art to make or use the invention. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

We claim:

1. A beam clamp comprising:
a clamp body that includes:
a first side wall that forms a first hook profile and a second side wall that forms a second hook profile, the first and second hook profiles being arranged to receive a beam simultaneously to hang the clamp body from the beam, and the second side wall including an aperture;
a first cross-wall that extends between the first and second side walls at a first end of the clamp body, the first cross-wall including a first threaded opening and a second threaded opening, the first threaded opening being sized to receive and threadedly engage a threaded rod along a first axis; and
a second cross-wall that extends between the first and second side walls at a second end of the clamp body that is opposite the first end, the second cross-wall extending integrally from the first side wall and including:
a third opening aligned with the first threaded opening along the first axis to receive the threaded rod along the first axis when the threaded rod extends through the first threaded opening; and
a tab that is received into the aperture in the second side wall so that contact between the tab and a wall of the aperture blocks movement of the tab in a direction perpendicular to the first axis.

2. The beam clamp of claim 1, wherein the first side wall includes:
a first cylindrical protrusion that includes first internal threads and defines the first threaded opening; and
a second cylindrical protrusion that includes second internal threads and defines the second threaded opening.

3. The beam clamp of claim 2, wherein the first cylindrical protrusion defines a first tapered entry to the first internal threads and the second cylindrical protrusion defines a second tapered entry to the second internal threads.

4. The beam clamp of claim 1, wherein the clamp body is configured to be selectively installed on the beam in a first orientation or in a second orientation to hang the threaded rod at the first threaded opening to support a load hanging in a first direction or in a second direction, respectively;
wherein a set screw extends through the second threaded opening to secure the clamp body to the beam in the first and the second orientations; and
wherein the threaded rod extends through the third opening with the clamp body in the first orientation.

5. The beam clamp of claim 4, wherein the third opening is not threaded.

6. The beam clamp of claim 5, wherein the third opening is oblong.

7. The beam clamp of claim 6, wherein a major axis of the third opening is aligned along a direction between the first and second side walls.

8. The beam clamp of claim 5, wherein the third opening is aligned with the tab along a line that extends perpendicularly between the first and second side walls.

9. The beam clamp of claim 4, wherein the first cross-wall is above the second cross-wall in the first orientation and below the second cross-wall in the second orientation.

10. The beam clamp of claim 1, wherein the first and second side walls extend integrally from the first cross-wall.

11. The beam clamp of claim 1, wherein the third opening is a closed-sided opening.

12. The beam clamp of claim 1, wherein the aperture is a recess extending into an edge of the second side wall at an end of the clamp body; and
wherein the tab is secured in the recess with a press fit engagement.

13. A beam clamp comprising:
a first side wall with a first C-shaped profile configured to receive a beam;
a second side wall with a second C-shaped profile configured to receive the beam simultaneously with the first C-shaped profile;
a first cross-wall that extends integrally from and between the first and second side walls at a first end of the beam clamp, the first cross-wall including an extruded first threaded opening that defines a first axis to receive a threaded rod and an extruded second threaded opening that defines a second axis to receive a set screw; and
a second cross-wall that extends integrally from the first side wall and between the first and second side walls at a second end of the beam clamp, the second cross-wall including an unthreaded third opening aligned with the extruded first threaded opening along the first axis.

14. The beam clamp of claim 13, wherein a notch extends into an edge of the second side wall at the second end of the beam clamp, and wherein a tab of the second cross-wall engages the notch in the second side wall.

15. A method of installing support system comprising:
providing a beam clamp including a clamp body with a first side wall that forms a first hook profile to receive a beam, and a second side wall that forms a second hook profile to receive the beam, a first cross-wall that extends between the first and second side walls at a first end of the clamp body, and a second cross-wall that extends between the first and second side walls at a second end of the clamp body that is opposite the first end, the second cross-wall extending integrally from the first side wall, and the second cross-wall including a tab that is received into an aperture in the second side wall at the second end of the clamp body;
aligning a threaded rod with a first opening disposed in the second cross-wall;
tightening the threaded rod into a second threaded opening disposed in the first cross-wall and aligned with the first opening; and
tightening a set screw into a third threaded opening disposed in the first cross-wall to secure the beam within the first and second hook profiles.

16. The method of claim 15 further comprising:
selectively orienting the beam clamp to be installed in either of a first orientation or a second orientation;
wherein, in the first orientation, the threaded rod extends through the first opening and the third threaded opening to support a load hanging in a first direction, with the set screw extending through the second threaded opening to engage an upper surface of the beam; and
wherein, in the second orientation, the threaded rod extends through the third threaded opening to support a load hanging in a second direction, with the set screw extending through the second threaded opening to engage a lower surface of the beam.

17. The method of claim 16, wherein, in the second orientation, the threaded rod extends through the first opening.

18. The method of claim 15, wherein the threaded rod extends through the first opening, and wherein the threaded rod is configured to engage a rear wall of the first opening.

19. The method of claim 18, wherein the threaded rod remains substantially straight within a volume of the beam clamp defined between the first and second side walls.

20. The method of claim 15, wherein the first and second side walls extend integrally from the first cross-wall.
